(19) United States
(12) Patent Application Publication
(10) Pub. No.: US 2004/0264364 A1
(43) Pub. Date: Dec. 30, 2004

(54) Network system for building redundancy within groups

(75) Inventor: So Sato, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/875,581

(22) Filed: Jun. 25, 2004

(30) Foreign Application Priority Data
Jun. 27, 2003 (JP) 2003-184688

(51) Int. Cl. H04L 12/413

(52) U.S. Cl. 370/217; 370/221; 370/225

(57) ABSTRACT

A redundant configuration is realized by building redundancy within groups that are made up of a plurality of nodes in a layer 2 network, whereby paths can be switched in a short time interval without limiting the network scale. First nodes transmit and receive messages within a group, these messages containing information that relates to the redundant configuration and that reflects link states. The second node is connected to a plurality of first nodes by way of the plurality of links that form redundant configuration sets, and transfers messages that are transmitted from any first node to other first nodes within the same group. Each of the first nodes determines the states of its own ports that are the objects of control in the redundancy structure within the group in accordance with the priorities of the ports that are the objects of control that are determined by transmitting and receiving messages.

### BACKGROUND OF THE INVENTION

1. Field of the Invention

The present invention relates to the redundant configuration of a network.

2. Description of the Related Art

Spanning tree protocol (hereinbelow abbreviated to “STP”) is known as a protocol for building redundancy in a network (for example, refer to Japanese Patent Laid-Open Publication No. 2001-268104).

Normally, redundant links are provided in a network to improve reliability against failures in communication devices and transmission paths, whereby a plurality of routes can be selected.

However, a plurality of selectable routes creates the possibility of the formation of loops in a network. In particular, the existence of a loop in a layer 2 network raises the problem that a broadcast frame will continue in a loop and thus create a broadcast storm.

STP both builds redundancy within a broadcast domain that includes a plurality of bridges in layer 2 and solves the problem of broadcast storms. In STP, the bridges within a broadcast domain exchange bridge IDs and port information with each other to proceed through such steps as selecting route bridges and selecting ports to block and thus determine the spanning tree topology that is composed of the paths for transmitting frames. When a link failure occurs, the bridges or ports that can no longer be used are excluded and a new spanning tree topology is determined. This building of redundancy in layer 2 improves reliability against failures in the network.

As described hereinabove, STP allows communication to be resumed by new routes despite the occurrence of a failure. However, STP suffers from the problem of lengthy convergence time when a failure occurs or when communication is recovered.

In STP, time is required to recognize whether or not loops have formed, and bridges do not forward frames during this time interval. This time interval varies according to the setting of parameters, but typically requires as much as 30-50 seconds for the determination of the spanning tree topology and the resumption of frame forwarding. In contrast, a time interval of 1-2 second is normally required as the recovery time for link failures.

In addition, the operation of STP is greatly influenced by the network scale. In a large-scale network (broadcast domain), the number of node stages that are connected by bridges increases, and the transmission delay of messages between bridges in a broadcast domain also increases.

When a failure occurs or during recovery, changes in state are transmitted and received between bridges by messages. The failure of these messages to arrive within a time interval that is set as a timer for recognizing loops raises the possibility that a loop has formed in the spanning tree topology.

There is a trade-off between the number of these node stages and the route convergence time, an increase in the number of node stages entailing an extension of the convergence time, and a shortening of the convergence tinge necessitating a limitation of the number of node stages. The network is therefore not expandable, and is in fact limited to 16-17 stages.

In STP, moreover, the redundant configuration and operation are complex, and when the tree topology is changed by the occurrence of a failure, the specification of the location of the failure becomes extremely problematic. The occurrence of a failure necessitates restorative operations such as the exchange or repair of cables or communication devices, and difficulty in specifying the point of failure not only increases the working processes, but also lengthens the work time.

In regard to maintenance and supervision, the tree topology that is selected as the actual route is difficult to ascertain for the same reasons, with the resulting problem that network management cannot be adequately achieved.

Further, when the network configuration in STP is modified by the installation of additional communication devices and cables, the tree topology is recalculated, and since such modifications influence the already existing portion that is in operation, frames cannot be transmitted until the tree topology has been determined.

Finally, in a VLAN in which a broadcast domain is constructed virtually, STP recognizes VLANs by means of VLAN tags and constructs one tree topology by VLAN units. As a result, in a hierarchical VLAN network in which VLAN tags that are defined by the IEEE 802.1Q standards are stacked, the VLANs that are placed in a hierarchy that is indicated by the stacked VLAN tags are not recognized and a tree topology is therefore not constructed.

### SUMMARY OF THE INVENTION

It is an object of the present invention to provide both a network having a redundant configuration that is capable of rapid switching of paths without any restrictions on the network scale in layer 2, as well as the node devices in such a network.

To achieve the above-described object, the network system of the present invention is a layer 2 network system that has a redundant configuration and that includes a plurality of first nodes and at least one second node.

The first nodes that together have ports that are the objects of control that are connected to a plurality of links that make up redundant configuration sets belong to the same groups, which are the units of redundant structure. The first nodes then determine the states of their own ports that are the objects of control in the redundant structure within the group according to the priority of ports that are the objects of control that is determined by the transmission and reception within the group of messages that contain information that relates to the redundant configuration and that reflects the link states. The second node is connected to the plurality of first nodes by way of the plurality of the links that make up the redundant configuration sets, and transmits messages that are transmitted from any first node to other first nodes within the same group.

In addition, the first nodes may control whether or not to transmit ordinary frames at ports that are the objects of control in accordance with the states of the ports that are the objects of control and thus select paths in the redundant configuration. Further, information relating to a redundant configuration may contain the priority.

Finally, first nodes may transmit ordinary frames at their own ports that are the objects of control when these ports that are the objects of control have the highest priority within a group.

The above and other objects, features, and advantages of the present invention will become apparent from the following description with reference to the accompanying drawings, which illustrate examples of the present invention.

### BRIEF DESCRIPTION OF THE DRAWINGS

FIG. 1 shows the configuration of a network of the first embodiment of the present invention;

FIG. 2 shows the content of each field that is included in an example of a redundancy-building frame;

FIG. 3 is a block diagram showing the configuration of a node of the present embodiment

FIG. 4 shows an example of the state transition of the ports of each node;

FIG. 5 is provided for explaining the operations of the network during a link abnormality; and

FIG. 6 shows the configuration of a network according to another embodiment of the present invention.

### DETAILED DESCRIPTION OF THE PREFERRED EMBODIMENTS

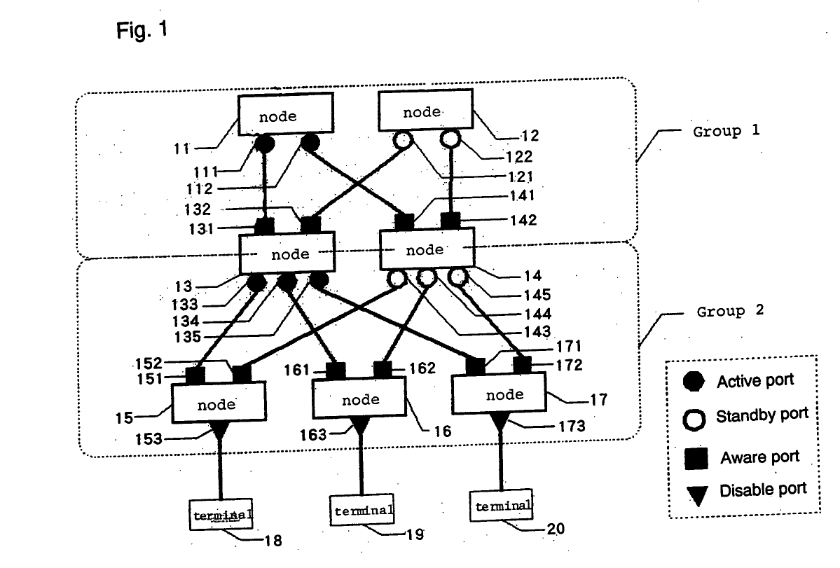

The network according to the present embodiment is a configuration in which a plurality of nodes is connected by Ethernet. Referring to FIG. 1, the network is made up by nodes 11-17. It will here be assumed that nodes 11-17 are bridges.

Port 111 of node 11 is physically connected to port 131 of node 13. Similarly, port 112 of node 11 is connected to port 141 of node 14, port 121 of node 12 is connected to port 132 of node 13, and port 122 of node 12 is connected to port 142 of node 14.

Port 133 of node 13 is connected to port 151 of node 15. Similarly, port 134 of node 13 is connected to port 161 of node 16, port 135 of node 13 is connected to port 171 of node 17, port 143 of node 14 is connected to port 152 of node 15, port 144 of node 14 is connected to port 162 of node 16, and port 145 of node 14 is connected to port 172 of node 17.

Terminal 18 is connected to port 153 of node 15. Similarly, terminal 19 is connected to port 163 of node 16, and terminal 20 is connected to port 173 of node 17.

Nodes 11-17 mutually exchange redundancy-building frames for controlling the redundant configuration and constructing paths to transmit frames.

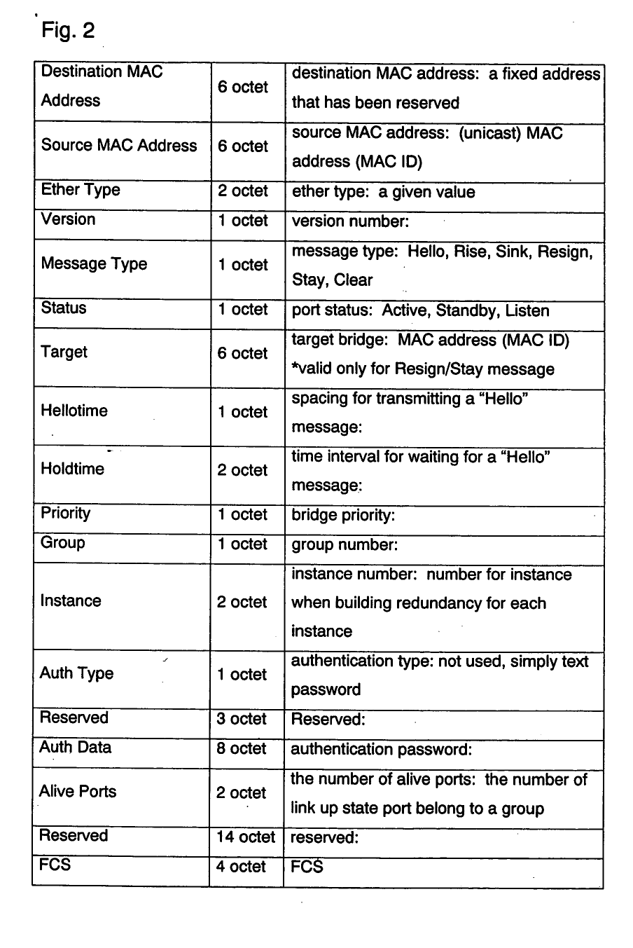

Referring now to FIG. 2, a redundancy building frame includes fields for: Destination MAC Address, Source MAC Address, the type of Ethernet (Ether Type), version number (Version), Message Type, the port status (Status), the target bridge (Target), the Hello message transmission spacing (Hellotime), the wait time for a Hello that has not yet been received (Holdtime), the bridge priority (Priority), the group number (Group), the instance number (Instance), the authentication type (Auth Type), the authentication data (Auth Data), the number of valid ports (Alive Ports), and the frame check sequence (FCS).

A fixed address that has been reserved is entered in the Destination MAC Address field. For example, the destination of the Hello message that is sent by node 11 in FIG. 1 is node 12.

The MAC address of the device is entered in the Source MAC Address field.

A value that indicates the type of Ethernet is entered in the Ether Type field.

The version number of the Ethernet is entered in the Version field.

A value indicating any type of message for building redundancy is entered in the Message Type field. Types of messages relating to redundant configuration include: “Hello,” “Rise,” “Sink,” “Resign,” “Stay,” and “Clear.”

A value indicating “Active,” “Standby,” or “Listen” is entered in the Status field as the port status among the nodes.

The target bridge field is valid only in a “Resign” message and “Stay” message, and the value of the MAC address of the target device is entered in this field. A “Resign” message is a message that is transmitted as a response when a node having an “Active” port receives a “Rise” message. The target device of a “Resign” message is the node that transmitted the “Rise” message. A “Stay” message is a message that is transmitted as a response when a node that has an “Active” port receives a “Sink” message. The target device of a “Stay” message is the node that transmitted the “Sink” message.

The Hellotime field is valid only for a “Hello” message, and a value indicating the spacing for transmitting a “Hello” message is entered in this field.

The Holdtime field is valid only for a “Hello” message, and a value indicating the time interval for waiting for a “Hello” message that is transmitted at a fixed transmission spacing is entered in this field. The reception timeout for a “Hello” message is measured by means of this value.

A value indicating the priority of nodes when selecting a path is entered in the Priority field.

The number of the group to which the port that is the object of control belongs is entered in the Group field.

When building redundancy for each instance, a number for distinguishing each instance is entered in the Instance field.

For example, when there is a multiplicity of VLANs, placing each VLAN in correspondence with any among a lesser number of instances and building the same redundancy for VLANs that are contained in the same instance enables a reduction of the number of redundant structures while distributing the load of links. When building redundancy for each instance in this way, a number indicating the instance is entered in this field.

The type of authentication that is used in the message is entered in the Auth Type field. A value indicating no authentication is entered when authentication is not used.

The password that is used in authentication is entered in the authentication data field (Auth Data).

Of the links that belong to groups that are the object of control, the number of links that are in the link “up” state (a state in which the link can be used) is entered in the Alive Ports field. The link status is changed by, for example, a link failure or the operation of a network manager.

A CRC arithmetic value for detecting errors is entered in the FCS field.

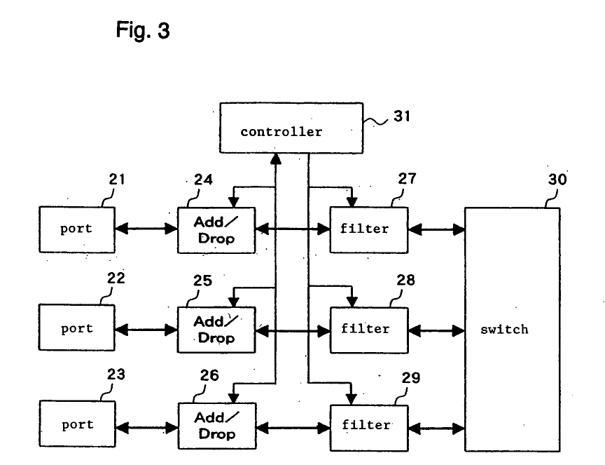

Referring now to FIG. 3, the nodes each include: ports 21-23, Add/Drop units 24-26, filters 27-29, switch 30, and controller 31.

Ports 21-23 are interfaces for connecting to other nodes or terminals, and monitor the link states and report to controller 31.

Add/Drop units 24-26 insert messages from controller 31 to other nodes into the main signal and transmit to ports, or separate messages from other nodes from the main signal and send these messages to controller 31.

Filters 27-29 discard frames in accordance with the instructions from controller 31.

Switch 30 forwards frames to desired destinations in accordance with a MAC learning table (not shown in the figure). The MAC learning table is a table for recording the correlation between MAC addresses and output ports that is obtained through learning (MAC learning).

Controller 31 transmits various messages to and receives various messages from other nodes by means of redundancy building frames such as the frame shown in FIG. 2, and manages the status of each port based on information that is obtained from other nodes and the link states that have been reported from other ports. Controller 31 then instructs each of filters 27-29 to discard or communicate frames in accordance with the status of each port.

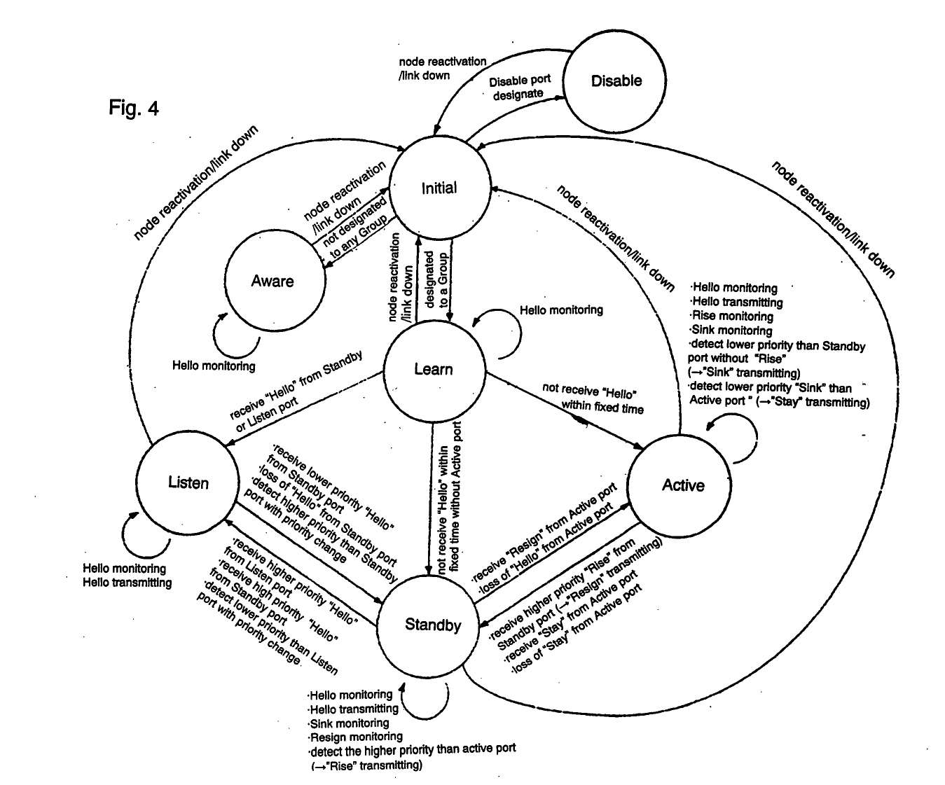

Each of the ports of each of nodes 11-17 undergoes state transitions in accordance with the state transition chart of FIG. 4 and assumes any of the states: “Initial,” “Learn,” “Listen,” “Standby,” “Active,” or “Aware.”

Referring now to FIG. 1, the links that are included in the network that is made up by nodes 11-17 are divided between two groups, Group 1 and Group 2, whereby each of the ports belonging to each of nodes 11-17 belongs to one group.

In the example shown in FIG. 1, ports 111, 112, 121, 122, 131, 132, 141, and 142 belong to Group 1, and ports 133-135, 143-145, 151, 152, 161, 162, 171, and 172 belong to Group 2. The control of the redundant configuration at times such as the occurrence of a failure is performed in these group units.

Each of nodes 11-17 can clearly specify to each of the ports belonging to that node the group to which that port belongs. Only one of the groups can be designated to one port. In addition, there are also some ports that are not clearly designated to a group.

Ports that are clearly designated to a group become the objects of control in building redundancy. Transitions in the state of a node are accompanied by transitions of the port states of ports that are the objects of control as shown in FIG. 4. For example, if a node makes a transition to the “Active” state, the port status of the ports that are the objects of control, that belong to that node, and for which a group is clearly designated also make the transition to “Active.”

In the example that is shown in FIG. 1, ports 111 and 112 and ports 121 and 122 are clearly designated to Group 1. Ports 133-135 and ports 143-145 are clearly designated to Group 2.

In contrast, ports 131, 132, 141, and 142 belong to Group 1, but this relation is not clearly designated. Further, ports 151-153, 161-163, and 171-173 belong to Group 2 but this relation is again not clearly indicated.

Each of nodes 11-17 can clearly designate “Disable” as the port status to the ports for which a group is not clearly designated. A “Disable” port is a port that is not influenced by the control of the redundant configuration, and for example, is connected to a circuit that lacks redundancy.

In the example of FIG. 1, ports 153, 163, and 173 are clearly designated “Disable.”

The ports for which a group is not clearly designated and that are not clearly designated “Disable” as the port status have “Aware” as the port status. “Aware” ports are connected to ports that are the object of control and are subordinate to these opposing ports.

In the example of FIG. 1, ports 131, 132, 141, 142, 151, 152, 161, 162, 171, and 172 are “Aware” ports.

In addition, regarding the ports of each of nodes 11-17 that are the object of control, bridge priority is clearly set for each of the groups to which the ports belong.

Regarding node 11 in the example of FIG. 1, “1” is clearly set as the bridge priority for group 1. As for node 12, “2” is set as the bridge priority for Group 1. Regarding node 13, “1” is set as the bridge priority for Group 2, and for node 14, “2” is set as the bridge priority for Group 2.

Upon activation, each of nodes 11-17 sends “Hello” messages that carry information relating to the redundant configuration of that node to the adjacent nodes. “Hello” is set as the message type in the frame of the format that is shown in FIG. 2. The information relating to the redundant configuration includes, for example: the group number (Group), bridge priority (Priority), number of valid ports (Alive Ports), port state (Status), Hello message transmission spacing (Hellotime), the wait time for a Hello that has not yet been received (Holdtime).

Each node periodically sends generated “Hello” messages from ports 111, 112, 121, 122, 133-135 and 143-145 for which the group is clearly designated. In addition, upon receiving a “Hello” message at ports 111, 112, 121, 122, 133-135 and 143-145 for which the group has been clearly designated, each node checks the information that is contained in the message and then discards the message.

For example, in the node of FIG. 3, a “Hello” message that is received at port 21 is extracted at Add/Drop unit 24 and then sent to controller 31, and further, discarded at filter 27 and therefore does not reach switch 30. The information that is contained in this “Hello” message is checked in controller 31 and then used in processing.

Returning to the explanation of FIG. 1, the nodes each do not send all of the messages relating to redundant configuration that have been generated by that node from ports 131, 132, 141, 142, 151, 152, 161, 162, 171, and 172 which have the “Aware” port status. However, upon receiving a message relating to redundant configuration by means of ports 131, 132, 141, 142, 151, 152, 161, 162, 171, and 172, which have the “Aware”, port status, the nodes check the information that is contained in this message and then transmit from prescribed ports in accordance with a bridge forwarding process. The bridge forwarding process is a process carried out by bridges for transferring frames according to the MAC learning table.

The nodes do not transmit either messages that have been generated by that node or messages that are received at other ports from ports 153, 163, and 173 having the “Disable” port status.

Nodes that have received “Hello” messages at ports for which the group is clearly designated or “Aware” ports recognize the group for which the message is intended from the value of the group number field that is contained in these messages. Based on information that is contained in a “Hello” message from a node of the same group to which that node belongs, each node then determines its own priority within the group, and in accordance with this priority, determines the port status of its own ports that belong to that group. This priority determines the control of redundant configuration within the group.

There are five port states: “Active,” “Standby,” “Listen,” “Aware,” and “Disable”; and of these, the “Aware” and “Disable” states are determined by a clear designation. The other states, “Active,” “Standby,” and “Listen,” are determined by priority. The ports belonging to the node having the highest priority become “Active” ports, the ports belonging to the node having the next highest priority become “Standby” ports, and ports having lower priority become “Listen” ports. Within one group, there will always be one node having “Active” ports and one node having “Standby” ports.

“Active” ports are ports that are valid for ordinary frames (hereinbelow referred to as “ordinary frames”) that are used in the transfer of signals other than messages that relate to redundant configuration (for example, user signals). “Standby” ports are ports that become “Active” in place of “Active” ports in which failures have occurred. This redundant configuration is a “hot standby” form in which “Standby” ports can immediately make the transition to “Active” ports when a link failure occurs in an “Active” port.

Among nodes having ports that belong to the same group, the node having the most ports in the link “up” state has the highest priority, and these ports become “Active” ports. The number of ports in the link “up” state is entered in the valid port number (Alive Ports) field in a “Hello” message, and each node therefore compares the number of ports in its own node that are in the link “up” state with the number of valid ports in the “Hello” messages from other nodes that belong to the same group to determine the status of its own node within the group. The port status of ports belonging to a node is determined from the status of the node within the group.

If the number of valid ports (Alive Ports) is the same, the node having the highest clearly set bridge priority has the highest priority, and the ports of that node become “Active” ports. Each node compares the bridge priority of its own node with the bridge priorities in “Hello” messages from other nodes belonging to the same group and determines the state of its own node within the group.

If the bridge priority is also the same value, the node having the highest MAC address value has the highest priority, and the ports of that node become “Active” ports. Each node compares the MAC addresses of its own node with the values of source MAC addresses in “Hello” messages from other nodes belonging to the same group to determine the status of its own node within the group.

In addition, the items of comparison that are shown here (number of valid ports (Alive Ports), bridge priority (Priority), and MAC addresses) and the order of their application are only for one example, and the present invention is not limited to this form. Further, the items of comparison and order of their application can be freely modified by settings. Still further, the highest priority may also be given to the node having the lowest value for MAC addresses.

In the example of Group 1 that is shown in FIG. 1, ports 111, 112, 211, and 212 are clearly designated to Group 1. These ports are therefore “Active” ports, “Standby” ports, or “Listen” ports. In this case, the nodes that hold ports that have been clearly designated to Group 1 are the two nodes, node 11 and node 12, and “Listen” ports therefore are not present.

Nodes 11 and 12 both have two valid ports (Alive Ports). In addition, the bridge priority of node 11 is “1,” and the bridge priority of node 12 is “2.” Accordingly, node 11 has higher bridge priority than node 12 and therefore has higher priority than node 12, whereby ports 111 and 112 become “Active” ports, and ports 121 and 122 of node 12 are “Standby” ports.

In the example of Group 2 that is shown in FIG. 1, ports 151, 152, 161, 162, 171, and 172 are neither clearly designated to a group nor designated as “Disable,” and these ports are therefore “Aware” ports. Ports 153, 163 and 173 are not clearly designated to a group but are clearly designated as “Disable,” and are therefore “Disable” ports.

Ports 133-135 and 143-145 are clearly designated to Group 2 and these ports are therefore “Active” ports, “Standby” ports, or “Listen” ports. In this case, only two nodes, node 13 and node 14, hold ports that are clearly designated to Group 2, and these nodes therefore have no “Listen” ports.

The number of valid ports (Alive Ports) for both of nodes 13 and 14 is “3.” In addition, the bridge priority of node 13 is “1” and the bridge priority of node 14 is “2”; and ports 133-135 of node 13 are therefore “Active” ports and ports 143-145 of node 14 are “Standby” ports.

The processing for ordinary frames changes according to the port status that has been thus determined. Ordinary frames are frames for sending data from users and not for sending messages between nodes.

Nodes perform forwarding of ordinary frames in accordance with a bridge forwarding process in “Active” ports, “Aware” ports, and “Disable” ports. In other words, ordinary frames that have been received at these ports are supplied as output from prescribed ports.

Nodes do not perform forwarding processing of ordinary frames at “Standby” ports or “Listen” ports.

In FIG. 1, upon transmitting ordinary frames of broadcast addresses from terminal 18, nodes 11, 13, and 15-17 perform flooding of these ordinary frames. Flooding is a process in which, upon receiving a frame from a particular port that has a prescribed MAC address, the frame is transmitted from all other ports. The MAC address of a frame that is to be flooded is a “broadcast address,” a “multicast address,” or a “unicast address that has not been learned by MAC learning.”

Ports 121 and 122 of node 12 are “Standby” ports, and ordinary frames that are received at these ports are discarded without undergoing the forwarding process. Ports 143-145 of node 14 are “Standby” ports, and ordinary frames that are received at these ports are therefore discarded without undergoing the forwarding process. In node 14, moreover, ordinary frames that are received at ports 141 and 142, which are “Aware” ports, are discarded at “Standby” ports 143-145 without undergoing the forwarding process.

In the event of the occurrence of an abnormality from these states in any node, port, or link, the port status of each port in the group undergoes a transition. Causes for the transition of port status include: a change in the valid port number (Alive Ports), i.e., the number of ports that are in the link “up” state; a modification of the bridge priority that has been clearly set in a node; the loss of a “Hello” message; and the detection of a “Resign” or “Stay” message. Nodes can recognize these causes by monitoring the redundancy-building message that is shown in FIG. 2.

Redundancy building messages are of six types: “Hello,” “Rise,” “Sink,” “Resign,” “Stay,” and “Clear.” Each node distinguishes the type by means of the message type field (Message Type).

A “Hello” message is a message between nodes that hold “Active” ports, “Standby” ports, or “Listen” ports for exchanging information relating to the redundant configuration that is recognized by the nodes.

Each node uses “Hello” messages to periodically report its own valid port number (Alive Ports), bridge priority (Priority), and MAC address to neighboring nodes.

A “Rise” message is a message that is transmitted when a node having a “Standby” port recognizes that its own priority has surpassed the priority of the node having an “Active” port and is to request a transition to “Active” node immediately. In order for a “Standby” port to make the transition to an “Active” port, the current “Active” port must assume another port status, and this change is prompted by the “Rise” message. Only a node having a “Standby” port can generate a “Rise” message, and a “Rise” message is transmitted from a “Standby” port.

A “Sink” message is a message that is transmitted when a node having an “Active” port recognizes that its own priority has fallen below that of a node having a “Standby” port or another node having an “Active” port and is to request a transition to “Standby” port immediately.

The existence of two or more “Active” ports is a transitional state. Transitional states occur when a newly installed node is connected to the network with its power ON or when networks that are in operation are connected together.

Only nodes that have an “Active” port can generate a “Sink” message, and a “Sink” message is transmitted from an “Active” port.

A “Resign” message is a message that is transmitted when a node that has an “Active” port has received a “Rise” message from a node having a “Standby” port that has higher priority than its own and is transmitted for reporting that the node is to make the transition to “Standby” port.

Only a node having an “Active” port can generate a “Resign” message, and a “Resign” message is transmitted from an “Active” port.

A “Stay” message is a message that is transmitted when a node having an “Active” port has received a “Sink” message from a node that similarly has an “Active” port but that has a lower priority than its own, and is transmitted to report that the node will remain with the “Active” port. In other words, a node that has an “Active” port permits the transition to “Standby” port by an “Active” port of another node having an “Active” port. Accordingly, only nodes that have an “Active” port can generate a “Stay” message, and a “Stay” message is transmitted from an “Active” port.

A “Clear” message is a message for requesting that the MAC learning table within a node be cleared. The MAC learning table is cleared when the “Active” port has been changed in order to allow the opposing node to transmit ordinary frames to the new “Active” port.

A node that has an “Active” port generates a “Clear” message when that port makes the transition to “Standby” port, and the “Clear” message is transmitted from a port that does not belong to the group that includes the ports that are the object of control.

Each node peeks at the information of these messages in “Aware” ports but does not transmit a generated message, and further, forwards the frames of messages that are received from other nodes.

Each node peeks at the information of these messages in “Disable” ports, but does not transmit a generated message, and further, does not forward messages that are received from other nodes.

Explanation next regards the state transitions of ports in the present embodiment. State transitions of ports are carried out by group units. In FIG. 4, a port that is in the “Initial” state is an “Initial” port, a port that is in the “Aware” state is an “Aware” port, and a port that is in the “Disable” state is a “Disable” port. The same holds true for other states.

Referring to the state transition chart of FIG. 4, each port immediately after activation is an “Initial” port. Subsequently, ports that are not designated to any group and are not designated “Disable” make the transition to the “Aware” state. Ports that are not designated to any group but that are clearly designated “Disable” make the transition to the “Disable” state. “Aware” ports and “Disable” ports do not undergo state transitions unless the node is reactivated or the link goes down.

Ports that are designated to any group make the transition from “Initial” state to “Learn” state.

“Hello” messages are monitored in “Learn” ports, but no frames, including redundancy-building messages, are generated, transmitted, or received. Nodes that have ports that have made the transition to the “Learn” state begin the measurement of fixed time intervals by means of a timer.

If absolutely no “Hello” messages are received by a “Learn ” port within the fixed time interval, the port makes the transition to the “Active” state. If no “Hello” message is received from nodes other than nodes having an “Active” port within the fixed time interval, the port makes the transition to the “Standby” state. When a “Hello” message is received from a node having a “Standby” or “Listen” port, the port immediately makes the transition to the “Listen” state.

When a node having an “Active” port receives a “Rise” message from another node having a “Standby” port, the node compares the priority of its own node with the priority of the other node that is found from the “Rise” message; and if its own node has lower priority, it transmits a “Resign” message and causes the “Active” port to make the transition to the “Standby” state.

Alternatively, if a node having an “Active” port detects by a means other than receiving a “Rise” message that the priority of its own port is lower than a “Standby” port, it sends a “Sink” message and holds the “Active” state.

If a node having an “Active” port receives a “Stay” message that indicates its own node in the target bridge field (Target) from another node that similarly has an “Active” port, it causes the “Active” port to make the transition to the “Standby” state.

If a node having an “Active” port receives a “Sink” message from another node that has an “Active” port that indicates a priority that is lower than its own “Active” port, it sends a “Stay” message and remains in the “Active” state.

If a node having an “Active” port does not receive a “Stay” message despite transmitting a “Sink” message to a node that similarly has an “Active” port for fixed time interval, it causes the “Active” port to make the transition to the “Standby” state.

When a node that has a “Standby” port receives a “Resign” message that indicates its own node in the target bridge field (Target) from another node that has an “Active” port, it causes the “Standby” port to make the transition to the “Active” state.

If a node that has a “Standby” port cannot receive a “Hello” message from another node that has an “Active” port within a fixed time interval, it causes the “Standby” port to make the transition to the “Active” state.

When a modification of the priority of its own node occurs in a node that has a “Standby” port, it compares the modification content with information from another node that has a “Listen” port that has been received beforehand by means of a “Hello” message, and if the priority of its own node is lower, it causes the “Standby” port to make the transition to the “Listen” state.

When a node that has a “Standby” port receives a “Hello” message from another node that has a “Listen” port, it compares the state of its own node with the information of the message, and if the priority of its own node is lower, it causes the “Standby” port to make the transition to the “Listen” state.

When a node that has a “Standby” port receives a “Hello” message from another node that has a “Standby” port, it compares that state of its own node with the information of the message, and if the priority of its own node is lower, it causes the “Standby” port to make the transition to the “Listen” state.

When a modification of the priority of its own node occurs in a node that has a “Listen” port, it compares the modification content with information from another node that has a “Standby” port that has been received beforehand by means of a “Hello” message, and if the priority of its own node is higher, it causes the “Listen” port to make the transition to the “Standby” state.

When a node that has a “Listen” port receives a “Hello” message from a node that has a “Standby” port, it compares the state of its own node with the information of the message, and if the priority of its own node is higher, it causes the “Listen” port to make the transition to the “Standby” state.

If a node that has a “Listen” port is unable to receive a “Hello” message from a node that has a “Standby” port within a fixed time interval, it causes the “Listen” port to make the transition to the “Standby” state.

Here, as an example of operation, it is supposed that, from the state in FIG. 1, a link abnormality occurs between port 133 of node 13 and port 151 of node 15. Because port 133 has entered the link “down” state, the valid port number (Alive Ports) in Group 2 of node 13 changes from “3” to “2.” Node 13 reports the modification of the valid port number (Alive Ports) to node 14 by means of a “Hello” message.

Node 14 receives the “Hello” message from node 13 that has an “Active” port, this message indicating that the priority of node 13 has been decreased. Node 14 therefore reports to node 13 its intent to cause a “Standby” port to make the transition to an “Active” port by means of a “Rise” message.

Node 13, upon receiving the “Rise” message from node 14 that now has higher priority than its own node, causes ports 134 and 135 to make the transition from “Active” ports to “Standby” ports and reports this information to node 14 by means of a “Resign” message.

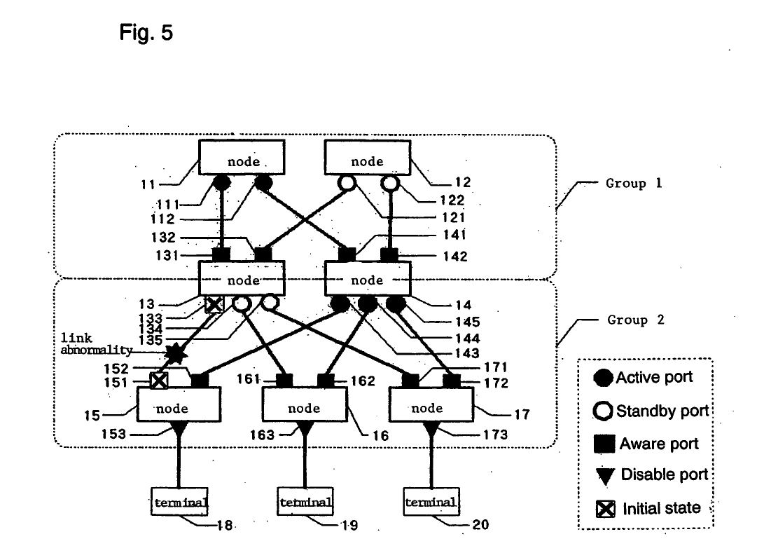

Node 14, having received the “Resign” message, causes ports 143-145 to make the transition from “Standby” ports to “Active” ports. By means of the above-described state transitions, the path that is shown in FIG. 5 is constructed in the network. In addition, the link abnormality between port 133 and port 151 has no effect on the redundant configuration of Group 1.

As yet another operating example, it is supposed that from the state that is shown in FIG. 5, the link between port 133 of node 13 and port 151 of node 15 has recovered the normal state. Due to the recovery of port 133, the valid port number (Alive Ports) for node 13 in Group 2 has changed from “2” to “3.” Node 13 compares the state of its own node with the information of node 14 that was received beforehand by means of a “Hello” message and recognizes from the bridge priority that the priority of its own node is higher.

Node 13 transmits a “Rise” message to node 14 to cause the transition of “Standby” ports 133-135 to “Active” ports. Node 14 receives from node 13 the “Rise” message that indicates that node 13 has higher priority than its own node. Node 14 therefore transmits a “Resign” message to node 13 and causes “Active” ports 143-145 of its own node to make the transition to “Standby” ports.

Having received the “Resign” message, node 13 causes “Standby” ports 133-135 to make the transition to “Active” ports. The above-described state transitions cause the network to return to the path configuration of FIG. 1. In addition, the recovery of the link between port 133 and port 151 has no effect on the redundant configuration of Group 1.

As described in the foregoing explanation, the redundant configuration was constructed in group units in the present embodiment, but the groups may also be further divided into instance units and the redundant configuration then controlled by instance.

Each node recognizes each instance within the group by means of the instance number field (Instance) shown in FIG. 2. In addition, instance numbers are numbers for identifying instances within a group, and the existence of an instance of the same value in another group is therefore absolutely distinct.

The plurality of VLANs can be mapped at each instance, but when the redundant configuration is to be constructed in VLAN units, the VLAN number value and the instance number value may be set to the same value. In such a case, instances exist in a number equal to the number of VLANs.

In addition, using the instance number value may be used for identifying nodes for building redundancy without using VLAN tags, and the message that is shown in FIG. 2 is transferred by means of untagged frame even when the node port is an IEEE 802.1Q VLAN tag port. Each node transfers all redundancy building messages by means of untagged frames.

As described in the foregoing explanation, a network that is realized by Ethernet is divided into a plurality of groups, and the redundant configuration in layer 2 is constructed by group, whereby paths are determined only by priority within the group, path modification has little influence upon the network, and further, paths are quickly determined upon the occurrence of a failure and recovery. Introducing the concept of groups, which are small networks having a configuration that is separate from the configuration of the layer 2 network (for example, a broadcast domain) into the redundant structure of layer 2, allows for a simplification of the redundant structure that was limited and complicated by the layer 2 network configuration.

In addition, the adoption of a redundant configuration of hot standby form by group means that the switching of paths is completed rapidly.

Further, the overall network scale has no influence upon the construction of the redundant configuration, and the layer 2 network scale is therefore unlimited.

Still further, in the event of a failure, the building of the redundant configuration is controlled within the group in which the failure occurred, and the point of failure can therefore be easily specified from within the group.

In addition, since the layer 2 redundant configuration is closed within each group, modifications of the physical topology of the network such as the installation of additional nodes can be easily carried out without influencing the already existing portion of the network.

In addition to “Active” ports and “Standby” ports, a plurality of “Listen” ports can be prepared, and the level of reliability of the redundant configuration can therefore be freely selected.

The redundancy building messages can be processed by means of untagged frames without using IEEE 802.1 Q VLAN tags, whereby a redundant configuration can be constructed that is independent of a VLAN network, and a redundant configuration can also be adopted in a VLAN network that is extended by stacking a plurality of VLAN tags.

Still further, within a group, the redundant configuration can be further divided into instance units, whereby a redundant network can be constructed in VLAN units or in units in which a plurality of VLANs units are combined, and the load on each link can thus be distributed.

Moreover, since the redundant configuration of a VLAN can be constructed in instance units, the parallel processes of constructing a redundant configuration can be cut when compared to constructing in VLAN units, and the amount of processing can therefore be reduced.

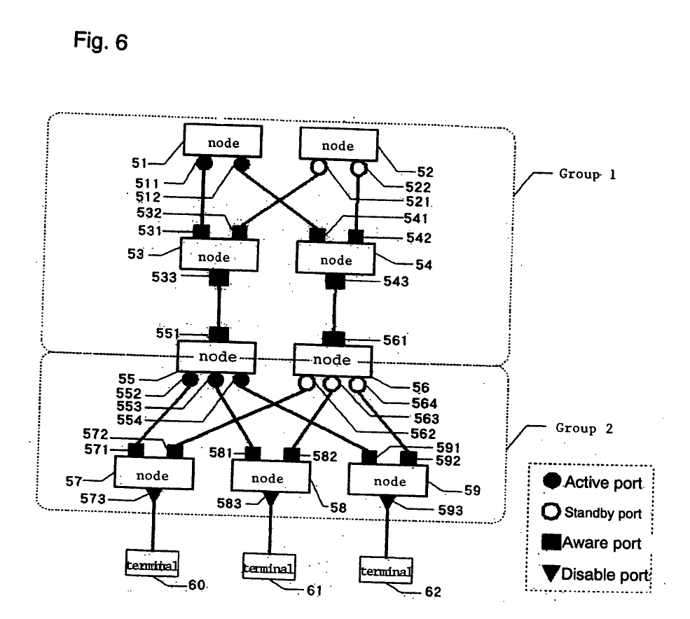

Explanation next regards another embodiment of the present invention. Referring to FIG. 6, a network is composed of nodes 51-59. In this case, nodes 51-59 are bridges.

Port 511 of node 51 is physically connected to port 531 of node 53. Similarly, port 512 of node 51 is connected to port 541 of node 54, port 521 of node 52 is connected to port 532 of port 53, and port 522 of node 52 is connected to port 542 of node 54.

Port 533 of node 53 is connected to port 551 of node 55, and port 543 of node 54 is similarly connected to port 561 of node 56.

Port 552 of node 55 is connected to port 571 of node 57, and similarly, port 553 of node 55 is connected to port 581 of node 58, port 554 of node 55 is connected to port 591 of node 59, port 562 of node 56 is connected to port 572 of node 57, port 563 of node 56 is connected to port 582 of node 58, and port 564 of node 56 is connected to port 592 of node 59.

Port 573 of node 57 is connected to terminal 60, and similarly, port 583 of node 58 is connected to terminal 61, and port 593 of node 59 is connected to terminal 62.

Nodes 51-59, similar to nodes 11-17 in FIG. 1, control the redundant configuration and mutually exchange redundancy-building frames for constructing paths for transferring frames.

However, even when a link abnormality occurs between port 533 of node 53 and port 551 of node 55 in FIG. 6, no change will occur in the priority of nodes 51, 52, 55, and 56 that have ports that are the objects of control for which groups have been clearly designated for either Group 1 or 2, because this link is a one-to-one node connection space. However, a route that passes by way of node 53 is not able to communicate frames and switching is therefore necessary to ensure the arrival of the frames.

In contrast to the nodes of FIG. 1, when specific ports in each of the nodes of the present embodiment are in a link “down” state, placing other ports that have been designated by setting in the link “down” state enables switching of ports that are the objects of control even if the ports that are the objects of control are not in the link “down” state. At such times, other ports may actually be placed in the link “down” state, or may be handled similarly to ports that are in the link “down” state.

More specifically, “Trigger” ports whose link states are to be monitored but that are not the objects of control, and “Depend” ports that immediately enter the link “down” state when “Trigger” ports are in the link “down” state are clearly set in each node. Then, when a “Trigger” port enters the link “down” state, each node causes the “Depend” ports to also enter the link “down” state. In addition, when a “Trigger” port is in the link “up” state, the “Depend” ports also enter the link “up” state.

In the example of FIG. 6, port 533 of node 53, port 543 of node 54, port 551 of node 55, and port 561 of node 56 may all be clearly set as “Trigger” ports.

In addition, ports 531 and 532 of node 53 may be clearly set as “Depend” ports” for port 533, which is a “Trigger” port. Ports 541 and 542 of node 54 may also be clearly set as the “Depend” ports for port 543, which is a “Trigger” port.

Ports 552-554 of node 55 may be clearly set as “Depend” ports for port 551, which is a “Trigger” port. Ports 562-564 of node 56 may be clearly set as “Depend” ports for port 561, which is a “Trigger” port.

For example, when a link abnormality occurs between port 533 of node 53 and port 551 of node 55, “Trigger” ports 533 and 551 assume the link “down” state. The link “down” state of these “Trigger” ports causes the “Depend” ports 531, 532, and 552-554 to enter the link “down” state.

In this way, ports 511 and 512 of node 51 make the transition from “Active” ports to “Standby” ports in Group 1. Further, ports 521 and 522 of node 52 make the transition from “Standby” ports to “Active” ports.

In Group 2, ports 552-554 of node 55 make the transition from “Active” ports to “Standby” ports. Further, ports 562-564 of node 56 make the transition from “Standby” ports to “Active” ports.

Thus, despite the occurrence of a link failure in a one-to-one node connection, the control of the redundant configuration of links in which the communication of frames is affected by the link failure and the switching of the path of frames ensures the arrival of the frames.

While preferred embodiments of the present invention have been described using specific terms, such description is for illustrative purposes only, and it is to be understood that changes and variations may be made without departing from the spirit or scope of the following claims.

What is claimed is:

1. A layer 2 network system having a redundant configuration, comprising:
a plurality of first nodes, each having ports under control connected to a plurality of links that form sets of redundant configurations, together belong to the same group that is the unit of the redundant structure, and further, each determine the state of their own ports under control in the redundant structure within said group in accordance with the priorities of said ports under control, said priorities being determined by transmitting and receiving messages within said group that contain information that relates to the redundant configuration and that reflects link states; and
at least one second node connected to a plurality of said first nodes by way of said plurality of links that form sets of redundant configurations for transferring said messages that have been transmitted from any first node to other first nodes within said group.

2. A network system according to claim 1, wherein said first nodes select paths in the redundant configuration by controlling, according to the states of said ports that are the objects of control, whether or not ordinary frames are transferred at said ports that are the objects of control.

3. A network system according to claim 1, wherein information relating to said redundant configuration contains said priorities.

4. A network system according to claim 1, wherein said first nodes transfer said ordinary frames at said ports that are the object of control when said ports of said first nodes have the highest priority within said group.

5. A network system according to claim 1, wherein information is clearly set beforehand indicating said group to which said ports of said first node, that are the objects of control, belong.

6. A network system according to claim 1, wherein said first nodes determine that the priority of the ports under control of said first nodes is the highest among the first nodes within said group, when said first nodes have the greatest number of ports under control in the link “up” state.

7. A network system according to claim 1, wherein:
a bridge priority is preset in each of said first nodes within said group; and
said first nodes determine that the higher the bridge priority, the higher said priority.

8. A network system according to claim 1, wherein:
at least one virtual network is formed within said network system; and
said first nodes determine the state of said ports that are the objects of control in the redundant configurations independently for each of instances into which said virtual networks are classified.

9. A network system according to claim 8, wherein said messages are identified by instance identification information.

10. A network system according to claim 1, wherein:
at least one virtual network is formed within said network system; and
said first nodes determine the states of said ports that are the objects of control in the redundant configuration independently for each of said virtual networks.

11. A network system according to claim 1, wherein, when said first and second nodes are connected by a link where no redundancy exists in said network, said first and second nodes treat a failure in this link as a failure of another link that forms a redundancy configuration set that is connected to said first and second nodes.

12. Node devices for making up a layer 2 network system having a redundant configuration, said node devices each comprising:
a plurality of ports that interconnect said node devices by links;
a controller for determining priorities of ports in its own node by transmitting and receiving by way of said ports messages to and from other node devices within a group to which said node devices belong that are each connected to a plurality of links that form sets of redundant configurations, said messages containing information that relates to the redundant configuration and that reflects link state, and in accordance with these priorities, determining the state of its own said ports in the redundant structure within said group;
Add/Drop units for sending, to said controller, said messages that have been received by said ports from other node devices, and for transmitting said messages from said controller to said other node devices from said ports;
filters for discarding frames that are transmitted and received at said ports according to the states of said ports that have been determined by said controller; and
a switch for transmitting ordinary frames that have been received from any port and that have not been discarded by said filters from other prescribed ports.

13. Node devices according to claim 12, wherein said controller, depending on the states of ports that are connected to links that form sets of redundant configurations, determines whether to discard or transmit said ordinary frames at said ports and instructs said filters.

14. Node devices according to claim 12, wherein said information that relates to redundant configuration contains said priorities.

15. Node devices according to claim 12, wherein said controller, when said ports that belong its own node device have the highest priority within said group, determines to transmit said ordinary frames at said ports.

16. Node devices according to claim 12, wherein said groups to which said node devices belong are determined in advance.

17. Node devices according to claim 12, wherein said controller determines that the priority of said ports that belong to, of said node devices within said group, the node device that has the greatest number of said ports that are in the link “up” state and that are connected to links that make up a redundant configuration set is the highest priority.

18. Node devices according to claim 12, wherein:
bridge priority is preset for each of said node devices within said group; and
said controller determines that the higher the bridge priority, the higher said priority.

19. Node devices according to claim 12, wherein:
at least one virtual network is configured within said network system; and
said controller determines the states of said ports in the redundant structure independently for each of instances into which said virtual networks are classified.

20. Node devices according to claim 19, wherein said messages are identified by instance identification information.

21. Node devices according to claim 12, wherein:
at least one virtual network is configured within said network system; and
said controller determines the states of said ports that are the objects of control in the redundant structure independently by said virtual networks.

22. Node devices according to claim 12, wherein, when said node devices are connected to a link that lacks redundancy in said network, said controller treats a failure in this link as a failure in another link that forms a redundant configuration set that is connected to its own node device.

23. A method for building redundancy of a layer 2 network system in each of nodes that make up said network system; said method comprising steps of:
determining priorities of ports that belong to a node by transmitting and receiving messages that contain information that relates to the redundant configuration and that reflects link states to and from other nodes within a group that are together connected to each of a plurality of links that form a redundant configuration set;
according to said priority, determining the states of said ports that belong to a node in a redundancy structure within said group; and
selecting paths by controlling whether or not to transmit ordinary frames at said ports that belong to a node depending on the states of said ports.

24. A method according to claim 23, wherein said ordinary frames are transmitted at ports that belong to a node and that are the objects of control when the ports have the highest priority within said group.

25. A method according to claim 23, wherein said information that relates to the redundant configuration contains said priority.

26. A method according to claim 23, wherein said ports under control belonging to the node having the greatest number of ports under control in the link “up” state within said group are determined to have the highest priority.

27. A method according to claim 23, wherein:
bridge priorities are preset for each of said nodes that have said ports that are the objects of control within said group; and
the higher said bridge priorities of the nodes, the higher said priority of said ports of the node.

28. A method according to claim 23, wherein:
at least one virtual network is formed within said network system; and
the states of said ports in said redundancy structure are determined independently for each of instances into which said virtual networks are classified.

29. A method according to claim 28, wherein said messages are identified by instance identification information.

30. A method according to claim 23, wherein:
at least one virtual network is configured within said network system; and the states of said ports that are the objects of control in said redundancy structure are determined independently for each said virtual networks.

31. A method according to claim 23, wherein, when said nodes are connected to a link that lacks redundancy in said network, a failure in this link is treated as a failure in another link that to which said nodes are connected and that forms a redundant configuration set.

32. A program for building redundancy of a layer 2 network system that is executed by each of nodes that make up said network system, said program comprising the steps of:
determining priority of ports belonging to a relevant node by transmitting and receiving messages to and from other nodes within a group to which belong nodes that are connected together to a plurality of links that form a redundant configuration set, said messages containing information that relates to the redundant configuration and that reflects link states;
determining states of said ports that belong to a relevant node in a redundancy structure within said group in accordance with the priorities; and
in accordance with said states of ports that belong to a relevant node, selecting paths by controlling whether or not to transmit ordinary frames at said ports.

33. A program according to claim 32, wherein, when said ports that are the objects of control and that belong to a relevant node have the highest priority within said group, said ordinary frames are transmitted at these ports.

34. A program according to claim 32, wherein said information that relates to the redundant configuration contains said priorities.

35. A program according to claim 32, wherein said ports that are the objects of control that belong to a node having the greatest number of said ports that are the objects of control that are in the link “up” state within said group are determined to have the highest priority.

36. A program according to claim 32, wherein:
bridge priorities are set in advance to each of said nodes that have ports that are the objects of control within said group; and
the higher these bridge priorities of said nodes, the higher said priority of said ports of these nodes is determined to be.

37. A program according to claim 32, wherein
at least one virtual network is configured within said network system; and
the states of said ports in said redundancy structure are determined independently for each instance into which said virtual networks are classified.

38. A program according to claim 37, wherein said messages are identified by instance identification information.

39. A program according to claim 32, wherein:
at least one virtual network is configured within said network system; and
states of said ports that are the objects of control in the redundancy structure are determined independently for each said virtual network.

40. A program according to claim 32, wherein, when said nodes are connected to a link in a space that lacks redundancy in said network, a failure of this link is treated as a failure of another link that forms a redundant configuration set that is connected to the node.
